(19) United States
(12) Patent Application Publication
(10) Pub. No.: US 2016/0077358 A1
(43) Pub. Date: Mar. 17, 2016

(54) EYEGLASSES FRAME, OPTICAL FRAME USED IN EYEGLASSES FRAME AND METHOD FOR MOUNTING EYEGLASSES FRAME

(71) Applicants: Joachim BISCHOFF, Keltern (DE); Mu Yin ZHENG, Longgang District, Shenzhen (CN)

(72) Inventor: Joachim Bischoff, Keltern (DE)

(21) Appl. No.: 14/786,559

(22) PCT Filed: Apr. 24, 2014
(86) PCT No.: PCT/EP2014/001088

§ 371 Date: Oct. 23, 2015

(30) Foreign Application Priority Data
Apr. 24, 2013 (DE) 10 2013 007 173.9

(51) Int. Cl. G02C 5/14; G02C 5/22; G02C 5/00; G02C 13/00

(52) U.S. Cl. CPC G02C 5/146; G02C 13/001; G02C 5/2209; G02C 5/008

(57) ABSTRACT

Provided herein is an eyeglasses frame, wherein one optical frame which can fix a lens and has two fixed segments is provided, one connecting segment of an eyeglasses leg is provided on the optical frame adjacent to each fixed segment, respectively, one end of the eyeglasses leg extends from a frame side to another end of the eyeglasses legs far away from the frame, the eyeglasses leg is fixed on the connecting segment, can be inverted, extends by being basically parallel to the optical frame at a first end and extends backwards from the optical frame at a second frame. Also provided herein is and optical frame used in the eyeglasses frame and a mounting method for the eyeglasses frame and eyeglasses.

### FIELD OF THE INVENTION

The invention relates to an eyeglasses frame according to claim 1, an optical frame mounted in the eyeglasses frame according to claim 11, eyeglasses comprising the eyeglasses frame according to claim 12, a mounting method of the eyeglasses frame according to claim 13, and a mounting method according to claim 14.

### BACKGROUND OF THE INVENTION

A wide variety of eyeglasses frames are available in the market, however they have the same basic structure: one frame is provided thereon with a fixed segment of two lenses, an eyeglasses leg is asway fixed on the fixed segment. The eyeglasses leg has the following inverting manner: each eyeglasses leg is basically parallel to the frame at a firs end and basically vertical to the frame at a second end, that is to say, it extends backwards until being vertical. Besides the fixed segment, the optical frame is provided thereon with one connecting segment for fixing the eyeglasses leg. Generally, a pair of the eyeglasses legs fixed on each connecting segment acts as supporting function and controls the inverting and folding.

Generally, the optical frame and the two eyeglasses legs are produced as a single component respectively mainly by a semi-automatic method. However, this semi-automatic method is still relatively troublesome, manual connection instead of automatic connection shall be carried out finally, furthermore, a folding shall be produced and mounted. Additionally, a very small screw shall be screwed up for fixation after final assembly.

### SUMMARY OF THE INVENTION

The invention provides an optical frame which can solve the above problems, have simple mounting and totally need not a screw for the fixation. Additionally, the used parts shall be molded, simple and low cost as much as possible.

The above problem is solved by the optical frame according to claim 1. The mounting method according to claim 13 is preferably adopted.

one of at least two connecting plates (generally, there are two) in the invention is provided with a connecting plate which extends from a lower end to an upper end and has an un-circular section (preferably a square section), the outer side of the connecting plate is provided with a female connector having a slot and a circular section and cannot be rotated. A connecting end of the eyeglasses leg is fixed on the female connector.

It is advantageous that an upper opening end of the slot of the connecting segment is upward, which can prevent it from detaching from by the user carelessly.

The mounting method introduced preferably according to the invention can very simply mount the eyeglasses leg on the connecting segment; firstly, the female connector is placed in the connecting end of the eyeglasses leg, and then the female connector is sleeved on the connecting plate under this state. The opening end of the slot of the female connector is upward, the opening end of a fixed segment of the eyeglasses leg is also upward. under this state, a fixed end of the eyeglasses leg connected with the female connector together is pushed into a first fixed segment along the direction from back to front so that the direction of the eyeglasses leg (or a component is directly connected with at least the connecting segment) is forward. In the next step, the eyeglasses leg is rotated backwards and preferably passes through the region of a fixed frame of a lens surrounding the fixed segment; the eyeglasses leg is required to be flexible.

The rotating radius of the eyeglasses leg is limited (currently, the eyeglasses frame available in the market also adopts the similar method, the rotating angle is basically 90°), one outer side connecting plate is preferably provided beside a first connecting plate according to claim 5.

### BRIEF DESCRIPTION OF DRAWINGS

FIG. 1 shows a total diagram of an eyeglasses frame of a preferable embodiment of the invention.

FIG. 2 shows a partial optical frame, one female connector and a fixed end of an eyeglasses leg in a first mounting step of FIG. 1.

FIG. 3 shows a second mounting step of FIG. 2.

FIG. 4 shows a third mounting step of FIG. 3, with an optical frame omitted.

FIG. 5 shows a fourth mounting step of FIG. 4 (a total diagram of an optical frame).

FIG. 6 shows a fifth mounting step of FIG. 4.

FIG. 7 shows an eyeglasses frame which has been mounted completely (similar to FIG. 1), and does not show an optical frame, similar to FIG. 5.

FIG. 8 shows a detailed diagram D in FIG. 7.

### DETAILED DESCRIPTION OF THE EMBODIMENTS

The following definitions are used: from a view angle of a supporting end of an eyeglasses frame, the definitions of “front”, “back”, “right”, “left”, “upper” and “lower” are determined. Particularly, “front” refers to the place far away from a head portion while “back” refers to the place adjacent to the head portion. The diagrams can be better understood through these definitions, the total diagram shows basically an optical frame from the same view angle, that is to say, from an inclined view angle from front to back.

The structure of the eyeglasses frame shown in FIG. 1 is firstly viewed: similar to other eyeglasses frames, the eyeglasses frame 10 is provided with one frame 12 thereon and two rotatable eyeglasses legs 30, 32 fixed on the outer edge of the frame. One end of the eyeglasses leg extends from one side of the optical frame to the other end of the eyeglasses leg far away from the optical frame, respectively.

The left side and the right side of the optical frame 12 which adopts preferably a NXT structure are provided with one fixed segment 14 and 16, respectively. The fixed segment 14 at the left side circles and forms a fixed region 14a of a lens at the left side, the fixed segment 16 at the right side circles and forms a fixed region 16a of a lens at the left side. As a structure example shown in the FIGS, the fixed segments 14, 16 are completely closed, from the view angle of mechanical strength, such a structure is preferably adopted, but it need not be a closed structure: particularly, it can also be designed to be a downward opening structure (half eyeglasses). Two fixed segments 14, 16 are connected with each other through one middle plate 18.

Each fixed segment 14, 16 is still provided with one connecting region 20, 20′ which is preferably designed as an integral structure, the eyeglasses leg 30, 32 is asway and fixed in the connecting region, respectively.

similar to other eyeglasses, the eyeglasses frame of the invention is also a symmetrical structure relative to a center surface; that is to say, two connecting regions 20, 20′ are also in minor symmetry. Such a structure is a preferable structure but is not required to be adopted.

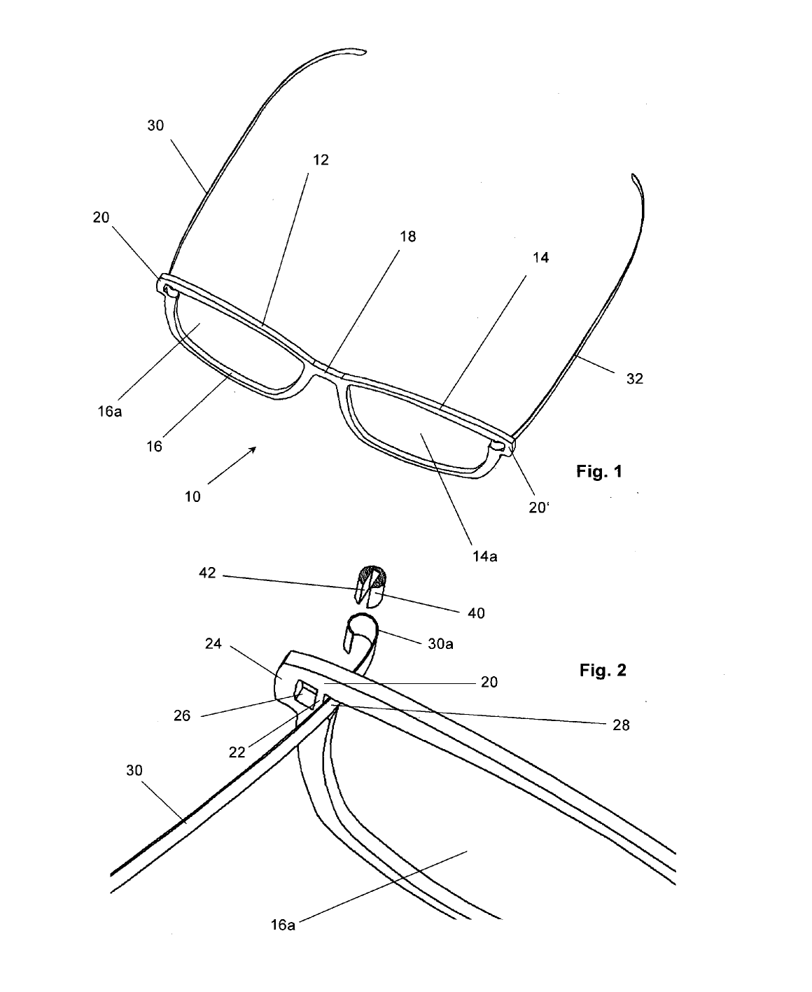

FIG. 2 shows a structure of a connecting segment, for example, the connecting segment 20 at the right side and the fixed segment of the eyeglasses leg, for example, the structure of the fixed segment 30a of the eyeglasses leg at the right side, and a female connector 40 between the fixed segment 30a and the connecting segment 20 of the eyeglasses leg 30.

The connecting segment 20 is firstly shown: the connecting segment is provided with a connecting plate from down to up, particularly a first connecting plate 22 and a second connecting plate 24. The ends of two connecting plates are not free, but closed and connected in the region of the optical frame 12, two connecting plates 22, 24 constitute one through hole 26 which is totally closed and has a square section. one opening hole 28 is provided between the fixed region 16a at the right side and the first connecting plate 22, the fixed region 16a at the right side can be directly entered through the opening hole, however, the opening hole does not belong to the region, as the opening hole 28 is used for fixing the eyeglasses leg at the right side but cannot be used for fixing the lens.

The section of the first connecting plate does not adopt a circular shape but preferably adopts a square shape. In the example of a shown structure, the length I of the square section is preferably longer than the width b thereof (for example, FIG. 4).

As described previously, the female connector 40 is a cylindrical component with a slot. That is to say, the section in the region outside of the slot 42 is circular. The slot extends in the axial region of a conical body, its length and width are the same with those of the section of the connecting plate 22. Additionally, the length of the female connector 40 is the same with that of the first connecting plate 22.

The eyeglasses leg 30 is in a bar shape, a first end constitutes a fixed end 30a, its shape is the three fourths of a hollow cylindrical structure, the section constitutes three fourths of a circle. The inner diameter is basically the same with the outer diameter of the female connector 40. The length of three fourths of the hollow cylindrical shape (that is to say, the height) is the same with the length of the female connector 40.

In the example of the shown structure, the eyeglasses is one component and preferably made of a robust elastic material, for example, a stainless steel. Meanwhile, the shown eyeglasses leg also can only constitute the core portion of the eyeglasses leg, a plastic sleeve or similar materials are pushed into the back portion of the eyeglasses leg, or in the subsequent work step, the partial eyeglasses leg can be coated with a plastic coating layer. Additionally, the region of the eyeglasses leg can be produced to be the relatively short fixed segment, with other work steps, a back segment is fixed on the fixed segment. The preferable object of the invention is to provide an eyeglasses frame with less single pieces and simple mounting, the preferably adopted eyeglasses leg (or at least core portion) is an integral structure, as shown in FIGS.

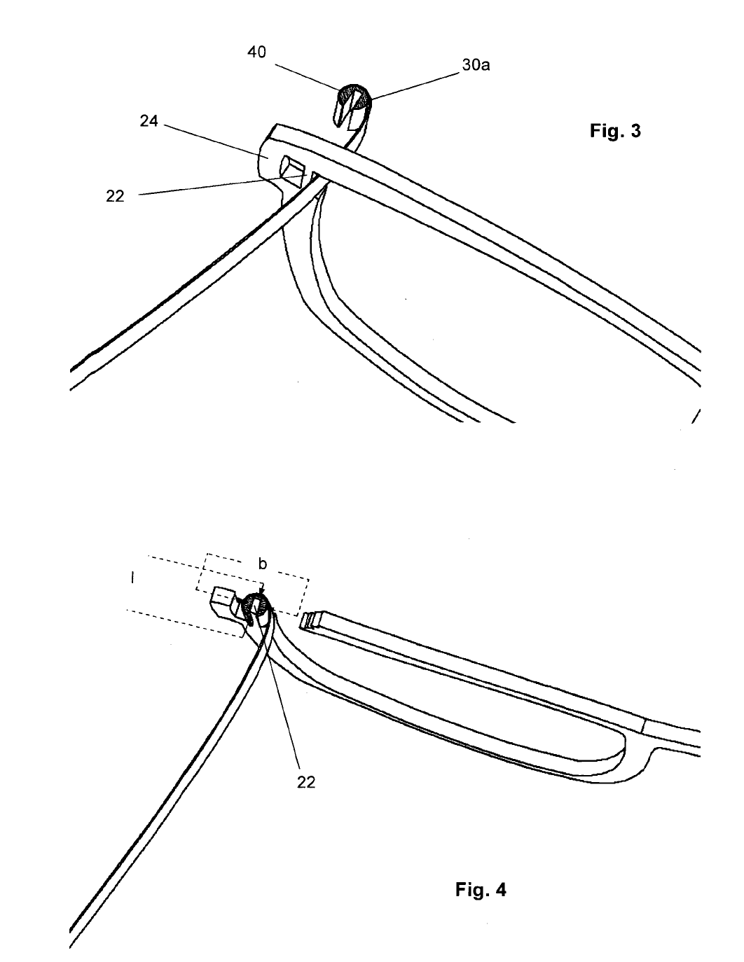

Three components shown in FIGS are simply mounted: firstly, the female connector 40 is axially sleeved into the fixed segment 30a of the eyeglasses leg 30, meanwhile, the preferably adopted size can ensure that the female connector 40 in the fixed segment 30a can be slightly blocked (FIG. 3). Now, the female connector 40 and the fixed segment 30a are moved from back to front and pushed into the first connecting plate 22, after the step is ended, the first connecting plate 22 is positioned in the slot 42 of the female connector 40. During the mounting, the eyeglasses leg 30 passes through the opening slot 28 or the fixed region 16a (FIG. 4).

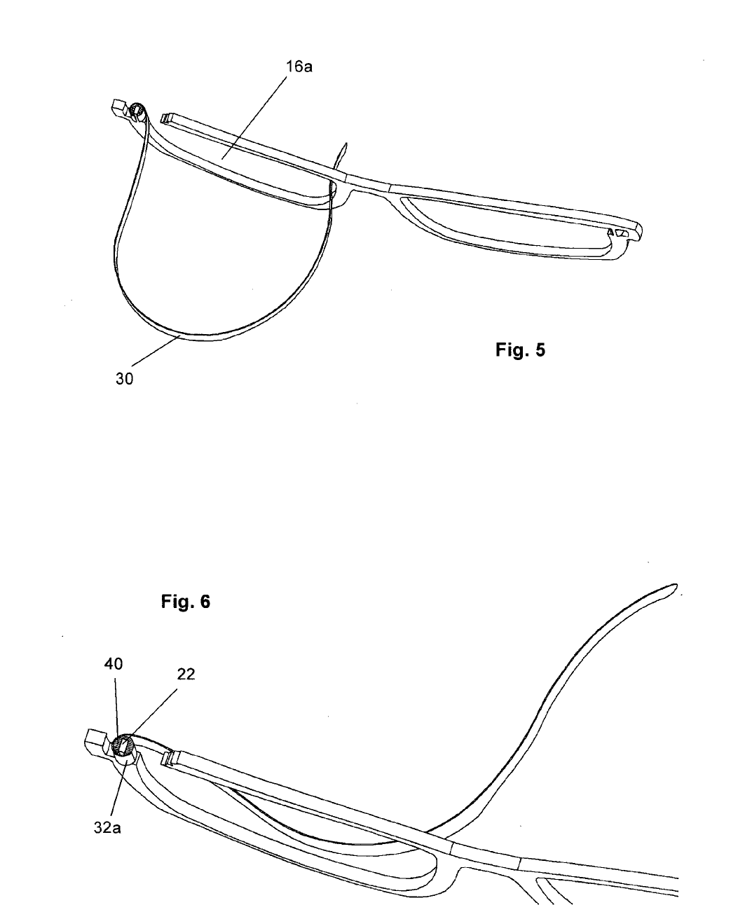

Now, as shown in FIG. 5, the eyeglasses leg 30 passes through the fixed region 6a at the right side and sways, in the shown structure example, the eyeglasses leg is made of the elastic material until the eyeglasses leg is positioned at the back end of the optical frame 12 (FIGS. 5, 6 and 7).

Under this state, the lens can be mounted in the fixed region.

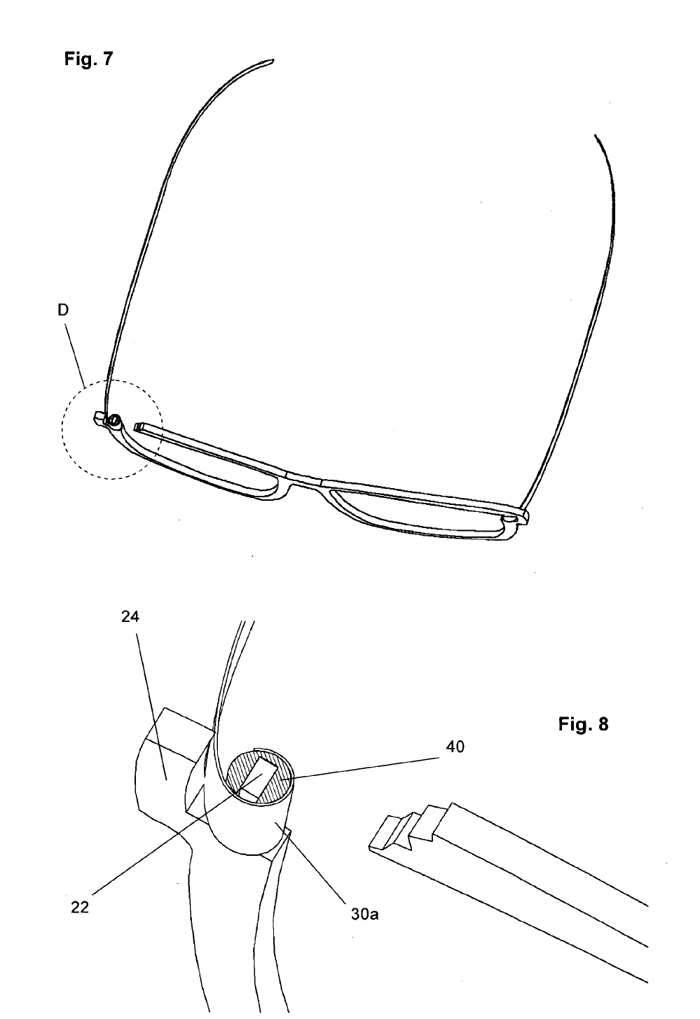

As shown in the detailed diagram of FIG. 8, the eyeglasses leg can be fixed on the first connecting plate of the connecting segment 20, as the opening end of the slot of the female connector 40 and the fixed segment of the eyeglasses leg 30 are not in the same region, and the eyeglasses leg can also be inverted inwards by 90° and reaches a first end place (a second end place shown in FIG. 7). As the outer section of the female connector 40 is circular and the inner section of the fixed segment 30a is also circular, they can be rotated with each other. The female connector is fixed on the first connecting plate 22, as the section of the connecting plate is not circular but square, they cannot be rotated with each other. An outward rotating angle is limited by the second connecting plate 2, as shown in FIG. 8.

As shown previously, according to the same manner, the eyeglasses leg 32 at the left side and the connecting segment 20′ are mounted.

In the example of the shown structure, the frame 12 is a single structure, and particularly a NXT structure. The connecting plate 22 also can be produced respectively and fixed in the region adjacent to the eyeglasses frame. The first connecting plate is preferably made of the stainless steel. Additionally, the whole eyeglasses frame can also be made of the stainless steel.

The invention also can adopt other structure manners: for example, an iron wire segment of the eyeglasses leg is circular or nearly circular section. Additionally, the long side of the cross section of the first connecting plate extends along a left side direction and a right side direction, respectively. By this manner, the female connector (see FIGS. 3 and 4) is moved outwards and inserted.

Other design structures can also be adopted.

Description of the Reference Signs

| | |
|---|---|
| 10 | Eyeglasses frame |
| 12 | Optical frame |
| 14 | Fixed segment at the left side |
| 14a | Fixed region at the left side |
| 16 | Fixed segment at the right side |
| 16a | Fixed region at the right side |
| 18 | Connecting plate at the middle |
| 20, 20′ | Connecting segment |
| 22 | First connecting plate |
| 24 | Second connecting plate |
| 26 | Through hole |
| 28 | Opening slot |
| 30 | Eyeglasses leg at the right side |
| 30a | Fixed segment |
| 32 | Eyeglasses leg at the left side |
| 32a | Fixed segment |
| 40 | Female connector |
| 42 | Slot |
| 44 | Outer wall |
| b | Width |
| I | Length |

1. An eyeglasses frame (10), comprising one optical frame (12) comprising two fixed segments (14, 16) of a lens, connecting segments (20, 20′) connected with eyeglasses legs (30, 32) are provided at the place close to each fixed segments (14, 16), respectively, one end of the eyeglasses leg (30, 32) extends from a frame side to the other end of the eyeglasses legs far away from the frame, the eyeglasses leg (30, 32) is fixed on the connecting segment (20, 20′), can be inverted, extends by being basically parallel to the optical frame at a first end and extends backwards from the optical frame at a second frame (12),
wherein the connecting segment (20, 20′) has at least one first connecting plate (22) extending from a lower end to an upper end, the section of the connecting plate is circular instead of being square;
the outer side of the first connecting plate (22) is connected with one slot female connector (40) with a circular outer section, and they cannot be rotated with each other, the first end of the eyeglasses leg fixed at the connecting segment (20, 20′) is connected with the female connector (40), the female connector constitutes a fixed segment (30a) with a rotating angle of more than 180°.

2. The eyeglasses frame according to claim 1, wherein the fixed segment (30a) surrounds the female connector (40) by an angle of less than 180°, as the end of the fixed segment (30a) where the eyeglasses leg (30) is inwards inverted is open.

3. The eyeglasses frame according to claim 2, wherein an opening end of a slot (42) of the female connector (40) is forward.

4. The eyeglasses frame according to claim 1, wherein the lower end and the upper end of the first connecting plate (22) are connected with the region adjacent to the optical frame (12), respectively.

5. The eyeglasses frame according to claim 1, wherein the outer side adjacent to the first connecting plate (22) is provided with a second connecting plate (24).

6. The eyeglasses frame according to claim 1, wherein the lens is fixed between the first connecting plate (22) and a fixed region (14a, 16a) adjacent to the first connecting plate (22), the fixed segment (14, 16) which is at least sectional type is distributed around the fixed region which is provided with one opening slot (28), the lens can be directly mounted in the fixed region (14a, 16a) through an opening.

7. The eyeglasses frame according to claim 6, wherein the continuous fixed segment (14, 16) is provided around the fixed region (14a, 16a).

8. The eyeglasses frame according to claim 1, wherein the eyeglasses leg (30, 32) is a single structure or a core portion constituting the eyeglasses leg, the fixed segment (32a) is one portion of the core portion of an integral type eyeglasses leg (30, 32) or the eyeglasses leg, the eyeglasses leg or the core portion of the eyeglasses leg is preferably made of stainless steel.

9. The eyeglasses frame according to claim 1, wherein the optical frame (12) is made of NXT.

10. The eyeglasses frame according to claim 1, wherein the eyeglasses are a symmetrical structure.

11. The optical frame (12) of the eyeglasses frame according to claim 1.

12. Eyeglasses comprising the eyeglasses frame according to claim 1, wherein the eyeglasses frame is provided with the fixed segment (14, 16) for fixing a lens.

13. A mounting method for the eyeglasses frame according to claim 1, comprising:
a) placing the female connector (40) into an unclosed fixed segment (32a) of the eyeglasses leg (30);
b) moving the female connector (40) from back to front, fixing the female connector (40) on the connecting segment (20), and positioning the eyeglasses leg (30) at the front end of the optical frame (12); and
c) passing the eyeglasses leg (30) or the core portion of the eyeglasses leg through the connecting segment (20) surrounded by the fixed segment (16) and adjacent to a fixed region (16a).

14. A mounting method of eyeglasses, wherein firstly mounting the eyeglasses frame (10) according to the mounting method of claim 13 and then placing a lens into the fixed region (16a).

15. The mounting method for the eyeglasses frame according to claim 13, wherein an opening end of a slot (42) of the female connector (40) is forward.

16. The mounting method for the eyeglasses frame according to claim 13, wherein the lower end and the upper end of the first connecting plate (22) are connected with the region adjacent to the optical frame (12), respectively.

17. The mounting method for the eyeglasses frame according to claim 13, wherein the outer side adjacent to the first connecting plate (22) is provided with a second connecting plate (24).

18. The mounting method for the eyeglasses frame according to claim 13, wherein the lens is fixed between the first connecting plate (22) and a fixed region (14a, 16a) adjacent to the first connecting plate (22), the fixed segment (14, 16) which is at least sectional type is distributed around the fixed region which is provided with one opening slot (28), the lens can be directly mounted in the fixed region (14a, 16a) through an opening.

19. The mounting method for the eyeglasses frame according to claim 13, wherein the continuous fixed segment (14, 16) is provided around the fixed region (14a, 16a).

20. The mounting method for the eyeglasses frame according to claim 13, wherein the eyeglasses leg (30, 32) is a single structure or a core portion constituting the eyeglasses leg, the fixed segment (32a) is one portion of the core portion of an integral type eyeglasses leg (30, 32) or the eyeglasses leg, the eyeglasses leg or the core portion of the eyeglasses leg is preferably made of stainless steel.
